(19) United States
(12) Patent Application Publication
(10) Pub. No.: US 2021/0261460 A1
(43) Pub. Date: Aug. 26, 2021

(54) EFFICIENT WETTING AGENT BY USING A SUPPORT MATERIAL

(71) Applicant: BASF SE, Ludwigshafen am Rhein (DE)

(72) Inventors: Bernhard FEICHTENSCHLAGER, Trostberg (DE); Martin PICHLER, Trostberg (DE); Michael SCHINABECK, Trostberg (DE); Fabian NIEDERMAIR, Trostberg (DE); Maria MUELLER, Trostberg (DE); Christoph HESSE, Trostberg (DE)

(73) Assignee: BASF SE, Ludwigshafen am Rhein (DE)

(21) Appl. No.: 17/261,675

(22) PCT Filed: Aug. 1, 2019
(86) PCT No.: PCT/EP2019/070798

§ 371 Date: Jan. 20, 2021

(30) Foreign Application Priority Data
Aug. 13, 2018 (EP) 18188791.0

(51) Int. Cl. C04B 24/32; C04B 28/00; C04B 28/04; C04B 28/06; C04B 28/08; C04B 28/10; C04B 28/14; C04B 28/18; C04B 40/00

(52) U.S. Cl. CPC C04B 24/32; C04B 28/006; C04B 28/04; C04B 28/06; C04B 40/0042; C04B 28/10; C04B 28/14; C04B 28/18; C04B 28/08

(57) ABSTRACT

A wetting agent composition may include (i) a wetting agent selected from the group consisting of anionic, cationic, nonionic wetting agents and a combination of these wetting agents, and (ii) a pulverulent carrier. A dry mixture may include such a wetting agent composition and at least one mineral binder, as may a wet mixture obtainable by mixing the dry mixture with water.

### TECHNICAL FIELD

The present invention relates to compositions comprising a mineral binder in dry and wet form, such as for example mortar compositions, concrete compositions, plaster compositions, screed compositions and similar compositions. In particular, the present invention relates to wetting agent compositions which can be used in the aforementioned compositions comprising a mineral binder.

### BACKGROUND OF THE INVENTION

Wetting agents are surface-active substances which facilitate the processing of pulverulent dry mixtures, that is to say pulverulent mixtures comprising a mineral (i.e. hydraulic or non-hydraulic) binder, in particular gypsum-based and cementitious mortars (spackling compounds, etc.). In a pulverulent dry mixture, wetting agents firstly have the task of accelerating the wetting of the pulverulent dry mixture in water in order for it to be possible to thus obtain a ready-to-process binder composition, for example fresh mortar, in the shortest possible time. Secondly, wetting agents have the task of enabling the wetting of the pulverulent dry mixture even in a minimal amount of water and hence of providing a mortar composition (fresh mortar) which can be readily processed and rapidly sets and dries to form an artificial stone composition with minimal shrinkage.

While these frequently gypsum-based and cementitious dry mixtures are pulverulent, wetting agents are often liquid or waxy and are difficult to obtain as a free-flowing powder. In such frequently gypsum-based and cementitious pulverulent dry mixtures, a waxy solid is thus used which is poorly available in the formulation as a result of slow dissolution and additionally has little flowability as a powder.

EP 2 006 258 B discloses dispersants for gypsum compositions which comprise comb polymers.

WO 2014/114784 A1 discloses an additive for hydraulically setting compositions, comprising a dispersant, at least one non-polymeric sulfonic acid compound and calcium silicate hydrate particles.

WO 2014/114782 A1 discloses a hardening accelerator composition based on calcium silicate hydrate, in particular a process for preparing such a hardening accelerator composition by reacting a calcium source selected from calcium hydroxide and calcium oxide with a water-soluble silicate compound in the presence of at least one water-soluble polymeric dispersant comprising anionic and/or anionogenic groups and polyether side chains.

WO 2015/185333 A1 describes a cementitious binder system which displays a rapid development over time of the dispersing action of the superplasticizer after addition of mixing water and simultaneously displays rapid hardening of the cementitious system. The composition comprises 5-50% by weight of calcium silicate hydrate, 10-60% by weight of at least one water-soluble, acid group-containing polymer comprising polyether groups, and 5-40% by weight of at least one polyalkylene glycol ether.

EP 1 518 923 A1 describes surfactant-containing compositions which are essentially composed of a) fatty alcohol alkoxylates, b) amorphous silica, c) carrier material and d) optionally customary auxiliaries, and which are suitable for use in detergent and cleaning compositions.

Against this background, in a first aspect it is an object of the present invention to provide a wetting agent composition which is present as a free-flowing powder and in which the wetting agent is present such that, on mixing the composition (for example as a constituent of a pulverulent dry mixture) with water, it rapidly dissolves and is thus available for accelerating the wetting of the dry mixture and for enabling the wetting of the dry mixture in a minimal amount of water.

In a further aspect, it is an object of the present invention to provide a pulverulent dry mixture which comprises this wetting agent composition and a mineral binder and hence is rapidly wettable when mixing with water even if a small amount of water is used.

In a third aspect, it is an object of the present invention to provide a binder composition which is obtained by mixing the aforementioned pulverulent dry mixture (comprising the wetting agent composition mentioned and a mineral binder) with water.

### BRIEF DESCRIPTION OF THE INVENTION

It has surprisingly been found that the first aspect of the object of the present invention can be achieved by providing a wetting agent composition comprising a wetting agent and a pulverulent carrier.

The second aspect of the object of the present invention can be achieved by providing a dry mixture comprising the aforementioned wetting agent composition and a mineral binder.

The third aspect of the object of the present invention can be achieved by providing a wet mixture which is obtained by mixing the aforementioned dry mixture (comprising the wetting agent composition mentioned and a mineral binder) with water.

### DETAILED DESCRIPTION OF THE INVENTION

The invention will be described in more detail below by way of the description of general and preferred embodiments.

In a first aspect of the present invention, a wetting agent composition comprising a wetting agent and a pulverulent carrier is provided in dissolved form. The components of this wetting agent composition are described hereinbelow.

—Wetting Agent

In the context of the present application, the term “wetting agent” denotes a chemical compound having amphiphilic properties, that is to say that the compound has at least one region in the molecule which has hydrophilic properties and at least one region in the molecule which has hydrophobic properties. Depending on the nature of the hydrophilic molecular moiety, a distinction is made between cationic wetting agents, anionic wetting agents and nonionic wetting agents. Cationic wetting agents have, as hydrophilic molecular moiety, a positively charged functional group such as for example a quaternary ammonium group (—N⁺R₃). Anionic wetting agents have, as hydrophilic molecular moiety, a negatively charged functional group such as for example a carboxylate group (—COO⁻), sulfonate group (—SO3⁻) or sulfate group (—OSO3⁻). Nonionic wetting agents have, as hydrophilic molecular moiety, an uncharged, that is to say neutral, functional group such as for example a hydroxyl group (—OH) or an ether group, in particular a methyleneoxy group (—O—CH₂—) or an ethyleneoxy group (—O—CH₂CH₂—). Each of these functional groups may be present one or more times in the hydrophilic molecular moiety. For example, an ether group such as an ethyleneoxy group may be present in the form of a polyether group in which for example 10 ethyleneoxy groups are linearly bonded to one another.

The hydrophobicity of a molecular moiety is a relative property, that is to say that the assessment of a molecular moiety as hydrophobic is done relative to the respectively other molecular moiety which is to be classified as hydrophilic. For cationic and anionic wetting agents, the distinction between the hydrophilic and the hydrophobic molecular moiety is comparatively clear since the molecular moiety comprising the cationically or anionically charged group can be classified as hydrophilic. For nonionic wetting agents, the distinction is generally made by comparing the hydrophobicity of the groups present in the molecule. For instance, a polyether group (for example formed from 10 ethyleneoxy groups bonded to one another) can be classified as hydrophilic compared to an alkyl group present in the same molecule. However, it is also possible to classify such a polyether group as hydrophobic, for example when a cationic or anionic group, for example a carboxylate group (—COO⁻), or when one or more hydroxyl groups (—OH) is/are present in the same molecule. This is known to those skilled in the art.

In the context of the present invention, nonionic wetting agents are preferred.

In particular, preference is given to nonionic wetting agents in which a molecular moiety is formed by ethylene oxide oligomers. Ethylene oxide oligomers consist of structural units which can be represented by the following formula, in which x can take a value of 1 to 100.

—(CH₂CH₂O)ₓ—H

For the sake of simplicity, the structural unit (—CH₂CH₂O—) derived from ethylene oxide is also represented in the context of this application by the abbreviation EO. Ethylene oxide oligomers of the formula —(CH₂CH₂O)ₓ—H can thus also be represented in abbreviated form by -EOₓ—. These ethylene oxide oligomers are linear, that is to say the repeating ethylene oxide structural units are bonded to one another without any branching of the molecular chain.

As explained, the classification of the molecular moieties as hydrophilic or hydrophobic depends on the environment in the molecule. A polyether group can be classified as hydrophilic or hydrophobic. In the nonionic wetting agents which are preferred in the context of the present invention, the molecular moiety formed by ethylene oxide oligomers may function as a hydrophilic molecular moiety or else as a hydrophobic molecular moiety.

The following classes of nonionic wetting agents comprise ethylene oxide oligomers and therefore constitute preferred nonionic wetting agents.

(1) Block Copolymers Formed from Ethylene Oxide Oligomers and Propylene Oxide Oligomers

This type of nonionic wetting agents consists of two terminal ethylene oxide oligomer blocks and a central propylene oxide oligomer block, and is also referred to as an EO-PO block copolymer. These block copolymers have the general formula

HO(CH₂CH₂O)ₓ—(CH₂CH(CH₃)O)_{y}—(CH₂CH₂O)_{z}H,

where 1≤x≤100,
1≤y≤100,
1≤z≤100.

Each of the terminal ethylene oxide oligomer blocks therefore constitutes an ethylene oxide oligomer. The propylene oxide oligomer block can be considered to be the hydrophobic molecular moiety, the ethylene oxide oligomer blocks can be considered to be the hydrophilic molecular moieties.

The central propylene oxide oligomer block consists of structural units which can be represented by the following formula, in which y can take a value of 1 to 100.

—(CH₂CH(CH₃)O)_{y}—

For the sake of simplicity, the structural unit (—CH₂CH(CH₃)O—) derived from propylene oxide is also represented in the context of this application by the abbreviation PO. Propylene oxide oligomers of the formula —(CH₂CH(CH₃)O)_{y}— can thus also be represented in abbreviated form by —PO_{y}—. These propylene oxide oligomers are linear, that is to say the repeating propylene oxide structural units are bonded to one another without any branching of the molecular chain. The methyl group present in the structural unit is thus not considered to be a branch of the propylene oxide oligomer.

Preference is given to EO-PO block copolymers of the general formula

HO(CH₂CH₂O)ₓ—(CH₂CH(CH₃)O)_{y}—(CH₂CH₂O)_{z}H,

where 1≤x≤100,
1≤y≤100,
1≤z≤100, and
5%≤(44x+44z)/(44x+58y+44z)≤90%.

More preference is given to EO-PO block copolymers of the general formula

HO(CH₂CH₂O)ₓ—(CH₂CH(CH₃)O)_{y}—(CH₂CH₂O)_{z}H,

where 1≤x≤100,
1≤y≤100,
1≤z≤100, and
10%≤(44x+44z)/(44x+58y+44z)≤80%.

The proportion by mass of the ethylene oxide oligomer blocks (expressed as 44x+44z) based on the total molecular mass (expressed as 44x+58y+44z) can thus be 5% or more and 90% or less.

More preference still is given to EO-PO block copolymers of the general formula

HO(CH₂CH₂O)ₓ—(CH₂CH(CH₃)O)_{y}—(CH₂CH₂O)_{z}H,

where 1≤x≤90,
13≤y≤70,
1≤z≤90,
10%≤(44x+44z)/(44x+58y+44z)≤80%.

In these EO-PO block copolymers, the central propylene oxide oligomer block thus has a mass in the range from 754 to 4060 g/mol.

The proportion by mass of the ethylene oxide oligomer blocks (expressed as 44x+44z) based on the total molecular mass (expressed as 44x+58y+44z) can thus be 10% or more and 80% or less. This relationship is fulfilled, for example, when x, y and z take the following values.
(a) x=z=1 and z=13
(b) x=z=90 and z=35
(c) x=5, z=6 and z=70
(d) x=1, z=2 and z=15
(e) x=20, z=21 and z=47
(f) x=z=2 and z=56
(g) x=z=36 and z=56

Particular preference is given to EO-PO block copolymers of the general formula

HO(CH₂CH₂O)ₓ—(CH₂CH(CH₃)O)_{y}—(CH₂CH₂O)_{z}H,

where 10≤x≤90,
25≤y≤60,
10≤z≤90,
10%≤(44x+44z)/(44x+58y+44z)≤80%.

In these EO-PO block copolymers, the central propylene oxide oligomer block thus has a mass in the range from 1450 to 3480 g/mol.

The proportion by mass of the ethylene oxide oligomer blocks (expressed as 44x+44z) based on the total molecular mass (expressed as 44x+58y+44z) is 10% or more and 80% or less. This relationship is fulfilled, for example, when x, y and z take the following values.
(a) x=z=10 and z=60
(b) x=z=90 and z=35
(c) x=5, z=5 and z=25
(d) x=z=45 and z=60
(e) x=20, z=21 and z=47

Most preference is given to EO-PO block copolymers of the general formula

HO(CH₂CH₂O)ₓ—(CH₂CH(CH₃)O)_{y}—(CH₂CH₂O)_{z}H,

where 10≤x≤90,
35≤y≤50,
10≤z≤90,
10%≤(44x+44z)/(44x+58y+44z)≤80%.

In these EO-PO block copolymers, the central propylene oxide oligomer block thus has a mass in the range from 2030 to 2900 g/mol.

The proportion by mass of the ethylene oxide oligomer blocks (expressed as 44x+44z) based on the total molecular mass (expressed as 44x+58y+44z) is 10% or more and 80% or less. This relationship is fulfilled, for example, when x, y and z take the following values.
(a) x=z=10 and z=50
(b) x=z=90 and z=35
(c) x=5, z=5 and z=35
(d) x=z=45 and z=60
(e) x=20, z=21 and z=47

Such block copolymers formed from ethylene oxide oligomers and propylene oxide oligomers are commercially available, for example under the trade name “Pluronic® PE” from BASF SE.

(2) Fatty Alcohol Alkoxylates

This type of nonionic wetting agents consists of an ethylene oxide oligomer as one molecular moiety and an alkoxy group as another molecular moiety. These fatty alcohol alkoxylates have the general formula

RO(CH₂CH₂O)ₓ—(CH₂CH(CH₃)O)_{y}—H,

where 2≤x≤80,
0≤y≤80,
R=C₈₋₁₈-alkyl or C₈₋₁₈-alkenyl with 1, 2 or 3 double bonds.

More preference is given to fatty alcohol alkoxylates of the general formula

RO(CH₂CH₂O)ₓ—(CH₂CH(CH₃)O)_{y}—H,

where 2≤x≤80,
2≤y≤80
R=C₁₂₋₁₈-alkyl or C₁₂₋₁₈-alkenyl with 1, 2 or 3 double bonds.

More preference still is given here to fatty alcohol alkoxylates of the general formula stated,

where 10≤x≤80,
y=0
R=C₁₆₋₁₈-alkyl or C₁₆₋₁₈-alkenyl with 1, 2 or 3 double bonds.

Particular preference is given here to fatty alcohol alkoxylates of the general formula stated,

where 30≤x≤80,
y=0
R=C₁₆₋₁₈-alkyl or C₁₆₋₁₈-alkenyl with 1, 2 or 3 double bonds.

Particular preference is likewise given to fatty alcohol alkoxylates of the general formula stated,

where 2≤x≤10,
2≤y≤10
R=C₁₂₋₁₄-alkyl.

Such fatty alcohol alkoxylates are commercially available, for example under the trade names “Lutensol® AT”, “Dehypon®” such as “Dehypon® LS 54” and “Disponil® A” from BASF SE.

(3) Polyethylene Glycols

This type of nonionic wetting agents consists of an ethylene oxide oligomer as one molecular moiety and an alkoxy group as another molecular moiety. These polyethylene glycols have the general formula

HO(CH₂CH₂O)ₓ—H,

where 3≤x≤210, preferably 5≤x≤150, more preferably 10≤x≤100, more preferably still 10≤x≤60, most preferably 10≤x≤40.

Such polyethylene glycols are commercially available, for example under the trade names “Pluriol® E” such as “Pluriol® E 600” from BASF SE.

In the context of the present invention, the wetting agent used can be a single compound or a combination of two or more different compounds. By way of example, it is possible as one embodiment to use two or more independently of one another from the compound classes (1) to (3) described above in combination with each other. In the context of this embodiment, mentioned as an example, it is thus possible to use a combination of two or more block copolymers formed from ethylene oxide oligomers and propylene oxide oligomers or a combination of a block copolymer formed from ethylene oxide oligomers and propylene oxide oligomers and of a fatty alcohol alkoxylate.

—Carrier

The carrier is a pulverulent material on the surface of which the wetting agent is applied to form the wetting agent composition according to the present invention.

The carrier is not particularly limited in terms of the particle size and the material, that is to say that the particle size and the material can be chosen independently of one another, wherein the carrier should be stable under the conditions of production, storage and use of the wetting agent composition as a constituent of a dry mixture or wet mixture, and the carrier should be sufficiently inert with respect to the wetting agent in order to prevent breakdown of the wetting agent or deterioration of the properties of the wetting agent. In addition, the carrier material should also not impair the properties of the dry mixture according to a further aspect of the present invention and of the wet mixture according to a further aspect of the present invention.

The carrier can generally have a particle size of 5-500 μm, the term “particle size” in relation to the carrier in the context of the present application having the same meaning as the term “particle size” in relation to the mineral binder which is a constituent of the dry mixture, and being able to be determined by the same method. The particle size of the carrier can for example be chosen so that it is similar to the particle size of the mineral binder, i.e. the d50 of the carrier is not smaller than 80% of the d50 of the mineral binder and not greater than 120% of the d50 of the mineral binder. The choice of a carrier having a small particle size generally leads to favorable flow characteristics of the wetting agent composition and of the dry mixture, but due to the higher proportions of particles having a particularly small particle size it can lead to a generally undesirable higher fine dust content of the wetting agent composition and of the dry mixture. Conversely, the fine dust content of the wetting agent composition and of the dry mixture can advantageously be kept low by choosing a carrier with a large particle size, but this can negatively impact the flow characteristics of the wetting agent composition and of the dry mixture.

Since the wetting agent is intended to be present on the surface of the carrier material, it is advantageous for the carrier to have a high surface area per unit weight, that is to say a high specific surface area. For example, carrier materials having a specific surface area of more than 10 m²/g, more than 20 m²/g, more than 30 m²/g or even more than 40 m²/g, can be used. The specific surface area can be determined by methods known to those skilled in the art, for example by a BET method using nitrogen.

In preferred embodiments, the carrier is an inorganic material. For example, the carrier in further preferred embodiments can be selected from silicon dioxide, silicates and aluminosilicates, alkaline earth metal carbonates, alkaline earth metal phosphates, pulverulent amorphous rock melts and mixtures of these.

In yet further preferred embodiments, the carrier can be selected from alkaline earth metal carbonates, alkaline earth metal phosphates, alkaline earth metal silicates, alkaline earth metal silicate hydrates and mixtures of these, preferably from magnesium carbonate, calcium carbonate, magnesium phosphate, calcium phosphate, magnesium silicate, calcium silicate, magnesium silicate hydrate, calcium silicate hydrate and mixtures of these, in particular from magnesium silicate hydrate, calcium silicate hydrate and mixtures of these.

In likewise yet further preferred embodiments, the carrier can be selected from sheet silicates and sheet aluminosilicates and mixtures of these, in particular bentonite, kaolin, montmorillonite and mixtures of these, natural silicon dioxide, such as kieselguhr, amorphous silicon dioxide, pyrolytic silicon dioxide, precipitated silicon dioxide and mixtures of these.

In particularly preferred embodiments, the carrier comprises calcium silicate hydrate, in particular having a specific surface area of 1 to 200 m²/g, particularly preferably of 30-150 m²/g, determined by the BET method by means of nitrogen sorption.

In further particularly preferred embodiments, the carrier consists of calcium silicate hydrate in particular having a specific surface area of 1 to 200 m²/g, particularly preferably of 30-150 m²/g, determined by the BET method by means of nitrogen sorption.

The composition of calcium silicate hydrate can be described generally by the following empirical formula:

a CaO, SiO₂, b Al₂O₃, c H₂O, d X, e W

where:

X is an alkali metal,

W is an alkaline earth metal,

0.1≤a≤2, preferably 0.66≤a≤1.8,

0≤b≤1, preferably 0≤b≤0.1,

1≤c≤6, preferably 1≤c≤6.0,

0≤d≤1, preferably 0≤d≤0.4,

0≤e≤2, preferably 0≤e≤0.1.

The calcium silicate hydrate is preferably at least partly in one or more of the following crystal structures: foshagite, hillebrandite, xonotlite, nekoite, clinotobermorite, tobermorite-9 Å (riversiderite), tobermorite-11 Å, tobermorite-14 Å (plombierite), jennite, metajennite, calcium chondrodite, afwillite, α-Ca₂[SiO₃(OH)](OH), dellaite, jaffeite, rosenhahnite, killalaite and/or suolunite, particularly preferably as xonotlite, tobermorite-9 Å (riversiderite), tobermorite-11 Å, tobermorite-14 Å (plombierite), jennite, metajennite, afwillite and/or jaffeite. In a further preferred embodiment, the calcium silicate hydrate is in amorphous form. The molar ratio of calcium to silicon in the calcium silicate hydrate is preferably from 0.6 to 2, preferably 0.8 to 1.8, particularly preferably 0.9 to 1.6, especially preferably 1.0 to 1.5. The molar ratio of calcium to water in the calcium silicate hydrate is preferably 0.6 to 6, particularly preferably 0.6 to 2 and especially preferably 0.8 to 2.

Concerning the production of calcium silicate hydrate, which is suitable as a carrier material for use in the present invention, reference is also made to the patent applications WO 2015/185333A1, WO 2014/114784 A1, WO 2014/114782 A1, WO 2010/026155 A1, WO 2011/026720 A1 and WO 2011/029711, the content of which is hereby incorporated into the application in full.

Calcium silicate hydrate is also commercially available in various particle sizes and with various specific surface areas. Types of calcium silicate hydrate usable as carrier in the context of the present invention are available, for example, under the name Circosil® from Cirkel GmbH & Co.KG, Haltern am See, Germany.

—Wetting Agent Composition

The wetting agent composition according to the present invention comprises (i) a wetting agent selected from anionic, cationic, nonionic and a combination of these wetting agents, and (ii) a pulverulent carrier. These components have been described above in general and with regard to preferred embodiments.

Although this has not been scientifically proven, it can be assumed that the wetting agent is arranged in finely divided form on the surface of the carrier, and due to this finely divided form can transition into an aqueous phase particularly rapidly, meaning that the wetting agent is rapidly available in the aqueous phase when producing the wet mixture according to a further aspect of the present invention by mixing water with the dry mixture according to a further aspect of the present invention. In this way, the desired properties of the wetting agent can become active and bring about a quick wetting of the constituents of the dry mixture.

The quantitative ratio of wetting agent and carrier in the wetting agent composition is not particularly limited, but it is desirable to keep the loading of the carrier with wetting agent sufficiently low that the surface of the carrier is not completely covered with wetting agent, since this would lead to an undesirably large amount of agglomeration and agglutination of the wetting agent-loaded particles of the carrier. In particular, the wetting agent in this case would also no longer be present in finely divided form on the surface of the carrier, and thus the desired rapid transition into an aqueous phase would no longer be guaranteed.

On the other hand, however, a high loading of the carrier is generally desirable in order to use the carrier as efficiently as possible. An approximation to an optimal combination of these effects can in general be achieved when the wetting agent is present in the wetting agent composition in an amount of 1-50% by weight, preferably 10-40% by weight, particularly preferably 20-35% by weight, based on the weight of the carrier.

A wetting agent composition comprising the wetting agent in this amount additionally has the advantage of being storage-stable even at elevated temperatures (for example of up to approximately 70° C.), even if the wetting agent has a melting point of approx. 30° C. This means in particular that no undesired clumping of the wetting agent composition, no bonding or sticking of the wetting agent composition to the container used for storage and no bleeding, that is to say escape of the wetting agent from the wetting agent composition, occurs.

If it is necessary to further optimize the quantitative ratio of wetting agent and carrier, those skilled in the art can plan and conduct simple experiments on the basis of the teaching in the present application. For example, those skilled in the art can determine the wetting time of a wetting agent composition comprising a particular wetting agent and a particular carrier for different quantitative ratios of wetting agent and carrier, as is described in the examples of the present application, in order to ascertain the quantitative ratio of wetting agent and carrier with which the shortest possible wetting time can be achieved.

In preferred embodiments of the wetting agent composition, the wetting agent is nonionic, the wetting agent in further preferred embodiments being selected from block copolymers formed from ethylene oxide oligomers and propylene oxide oligomers, fatty alcohol alkoxylates and polyethylene glycols, which have been described above in general terms and with regard to preferred embodiments, and combinations of these wetting agents.

In preferred embodiments of the wetting agent composition, the carrier is an inorganic material, the carrier in further preferred embodiments being selected from silicon dioxide, silicates and aluminosilicates, alkaline earth metal carbonates, alkaline earth metal phosphates, pulverulent amorphous rock melts, alkaline earth metal silicates, alkaline earth metal silicate hydrates and mixtures of these, which have been described above in general terms and with regard to preferred embodiments.

In further preferred embodiments of the wetting agent composition,

(i) the wetting agent is nonionic, wherein the wetting agent can in particular be selected from block copolymers formed from ethylene oxide oligomers and propylene oxide oligomers, fatty alcohol alkoxylates and polyethylene glycols, which have been described above in general terms and with regard to preferred embodiments, and combinations of these wetting agents, and

(ii) the carrier is an inorganic material, wherein the carrier can in particular be selected from silicon dioxide, silicates and aluminosilicates, alkaline earth metal carbonates, alkaline earth metal phosphates, pulverulent amorphous rock melts, alkaline earth metal silicates, alkaline earth metal silicate hydrates and mixtures of these, which have been described above in general terms and with regard to preferred embodiments.

In yet further preferred embodiments of the wetting agent composition,

(i) the wetting agent is selected from block copolymers formed from ethylene oxide oligomers and propylene oxide oligomers, fatty alcohol alkoxylates and polyethylene glycols, which have been described above in general terms and with regard to preferred embodiments, and combinations of these wetting agents, and

(ii) the carrier is selected from magnesium carbonate, calcium carbonate, magnesium phosphate, calcium phosphate, magnesium silicate, calcium silicate, magnesium silicate hydrate, calcium silicate hydrate and mixtures of these, in particular from magnesium silicate hydrate, calcium silicate hydrate and mixtures of these.

In yet further preferred embodiments of the wetting agent composition,

(i) the wetting agent is selected from block copolymers formed from ethylene oxide oligomers and propylene oxide oligomers, fatty alcohol alkoxylates and polyethylene glycols, which have been described above in general terms and with regard to preferred embodiments, and combinations of these wetting agents, and

(ii) the carrier comprises calcium silicate hydrate, in particular having a specific surface area of 1 to 200 m²/g, particularly preferably of 30-150 m²/g, determined by the BET method by means of nitrogen sorption.

In all of these embodiments of the wetting agent composition, the wetting agent is generally present in an amount of 1-50% by weight, preferably 10-40% by weight, particularly preferably 20-35% by weight, based on the weight of the carrier.

In particularly preferred embodiments, the wetting agent composition comprises at least one nonionic wetting agent, but does not comprise any anionic wetting agent.

In further preferred embodiments, the wetting agent composition comprises at least one nonionic wetting agent, but does not comprise any anionic wetting agent, and the at least one nonionic wetting agent is selected from block copolymers formed from ethylene oxide oligomers and propylene oxide oligomers, fatty alcohol alkoxylates, polyethylene glycols and combinations of these. Suitable block copolymers formed from ethylene oxide oligomers and propylene oxide oligomers, fatty alcohol alkoxylates and polyethylene glycols have been described above in detail.

In yet further preferred embodiments, the wetting agent composition comprises at least one nonionic wetting agent, but does not comprise any anionic wetting agent, and the at least one nonionic wetting agent is selected from block copolymers formed from ethylene oxide oligomers and propylene oxide oligomers, fatty alcohol alkoxylates, polyethylene glycols and combinations of these, wherein the at least one nonionic wetting agent is present in an amount of 1-50% by weight, preferably 10-40% by weight, particularly preferably 20-35% by weight, based on the weight of the carrier.

The wetting agent composition can comprise further components, for example free-flow aids such as calcium carbonate or fumed silica, which is commercially available under the trade names Sipernat® and Aerosil® (Evonik Industries AG, Essen, Germany). These further components can generally be present in an amount of 1-5% by weight, preferably 1-3% by weight, based on the weight of the wetting agent composition.

—Preparation of the Wetting Agent Composition

The wetting agent composition can be prepared by any method suitable for applying the wetting agent to the surface of the carrier.

For example, it is possible to apply the wetting agent to the carrier in a suitable form while mixing the pulverulent carrier. If the wetting agent is liquid at room temperature, the wetting agent can be sprayed onto the carrier at room temperature, with the carrier preferably being mixed in order to achieve a uniform loading with the wetting agent. If the wetting agent is solid at room temperature, it is conceivable to convert the wetting agent into liquid form by heating and to spray it onto the carrier.

It is also conceivable to disperse or dissolve the wetting agent in a suitable solvent, with heating also optionally being able to be performed, and to spray the dispersion or solution thus obtained onto the carrier. The solvent used can for example be water, monohydric and dihydric alcohols such as ethanol, propanol, isopropanol, butanol, their ether derivatives such as butyl glycol (i.e. ethylene glycol monobutyl ether) and ester derivatives with carboxylic acids such as ethyl acetate or butyl glycol acetate (i.e. 2-butoxyethyl acetate), and mixtures of these solvents. In this case it is then necessary to remove the solvent from the mixture of carrier and wetting agent. From this point of view it may be advantageous to use a mixture of at least two solvents which form a relatively low-boiling azeotrope. The solvent or solvent mixture can be removed by evaporation under reduced pressure and/or elevated temperature. If solvent is used in an amount sufficient to produce a sprayable suspension or dispersion of carrier and wetting agent in the solvent, the solvent can for example also be removed by spray drying. If the mixture of solvent, carrier and wetting agent is not sprayable, but is sufficiently flowable, roller drying or belt drying can be used. The dried mixture of wetting agent and carrier can optionally be aftertreated, for example in order to break up agglomerates of wetting agent-coated carrier particles, so that in the finished wetting agent composition there are no agglomerated carrier particles, but rather the particle size of the wetting agent composition essentially corresponds to the particle size of the (uncoated) carrier.

—Dry Mixture

In a further aspect of the present invention, a dry mixture is provided comprising the aforementioned wetting agent composition and a mineral binder.

In the context of the present application, the term “dry mixture” denotes a pulverulent composition comprising the aforementioned wetting agent composition and at least one mineral binder and also, as optional constituents, aggregates and/or adjuvants. Aside from the presence of the wetting agent composition, the dry mixture does not differ in its composition from customary dry mixtures known to those skilled in the art.

The particle size of the aggregates is not particularly limited. If the aggregates have such a particle size that they pass through a sieve with a mesh size of 4 mm, the dry mixture is also referred to as a dry mortar. If the aggregates have such a particle size that they do not pass through a sieve with a mesh size of 4 mm, the dry mixture is also referred to as dry concrete.

An aggregate can be selected from sediments and rock particles such as uncrushed sand, uncrushed gravel and crushed rock particles such as crushed stone, stone chippings, crushed sand and rocks.

Crushed sand typically refers to angular, crushed mineral substances having a particle size of between 0 and 2 millimeters. Stone chippings typically refer to angular, crushed mineral substances having a particle size of between 2 and 32 millimeters. Crushed stone typically refers to angular, crushed mineral substances having a particle size of between 32 and 63 millimeters. Sand typically refers to sediment made up of mineral grains having a particle size of between 0.063 and 2 millimeters. Gravel typically refers to sediment made up of mineral grains having a particle size of between 2 and 63 millimeters.

Adjuvants present in the dry mixture which may be mentioned include in particular pigments, dyes, rheology modifiers (thickeners, plasticizers), hydration modifiers (retarders, accelerators), superplasticizers, defoamers and air-entraining agents. These adjuvants do not differ in nature or amount from the adjuvants which are typically present in conventional dry mixtures known to those skilled in the art.

The dry mixture according to the invention comprises the wetting agent composition according to the present invention generally in such an amount that the wetting agent present in the wetting agent composition is present in an amount of 0.01-1% by weight, based on the weight of the constituents of the dry mixture, that is to say of the mineral binder and of the optional constituents mentioned (aggregates and/or adjuvants).

In preferred embodiments, the dry mixture comprises the wetting agent composition in such an amount that the wetting agent present in the wetting agent composition is present in an amount of 0.03-0.5% by weight, based on the weight of the constituents of the dry mixture.

In further preferred embodiments, the dry mixture comprises the wetting agent composition in such an amount that the wetting agent present in the wetting agent composition is present in an amount of 0.05-0.3% by weight, based on the weight of the constituents of the dry mixture.

In yet further preferred embodiments, the dry mixture comprises the wetting agent composition in such an amount that the wetting agent present in the wetting agent composition is present in an amount of 0.1-0.2% by weight, based on the weight of the constituents of the dry mixture.

—Mineral Binder

The mineral binder is selected from hydraulic binders and non-hydraulic binders and can be a single hydraulic binder, a single non-hydraulic binder, a combination of two or more hydraulic binders, a combination of two or more non-hydraulic binders or a combination of one or more hydraulic binders and one or more non-hydraulic binders.

The terms “hydraulic binder” and “non-hydraulic binder” are known to those skilled in the art.

In the context of the present application, the term “hydraulic binder” denotes a mineral binder which hardens both in air and under water, specifically in particular by chemical reaction with water (also called hydration), and remains solid thereafter.

In the context of the present application, the term “non-hydraulic binder” denotes a mineral binder which exclusively hardens in air, for example by taking up air constituents such as water or carbon dioxide from the air or by drying, that is to say releasing water into the surrounding air.

Examples of hydraulic binders usable in the context of the present invention which may be mentioned include gypsum, geopolymers, cement, in particular Portland cements or high-alumina cements and mixtures thereof with fly ash, silica fume, slag, slag sand and ground limestone or burnt lime, calcium sulfoaluminate, latent hydraulic binders such as pozzolans in combination with slaked lime, quicklime or cement.

In the context of the present application, the term “gypsum” refers to any known form of gypsum, in particular calcium sulfate dihydrate, calcium sulfate α-hemihydrate, calcium sulfate β-hemihydrate or calcium sulfate anhydrite.

Examples of non-hydraulic binders usable in the context of the present invention which may be mentioned include lime, i.e. generally slaked lime (Ca(OH)₂; also referred to as hydrated lime), but also quicklime (CaO; also referred to as burnt lime), calcined magnesium carbonate (MgO; caustic calcined magnesite) and loam. Slaked lime hardens by taking up carbon dioxide (CO₂) from the air, forming calcium carbonate and releasing water. Quicklime can be converted to slaked lime by reaction with water.

The mineral binder typically has a particle size of 5-500 μm, but the particle size is not particularly limited in the context of the present application. In the context of the present application, the term “particle size” corresponds to the median of the particle size mass distribution (d50), which can be determined by laser diffraction, for example using a CILAS 1064 type instrument.

—Wet Mixture

In a further aspect of the present invention, a wet mixture is provided which is obtainable by mixing the aforementioned dry mixture with water.

The wetting agent composition according to the present invention accelerates the wetting of the dry mixture and can make it possible to make up the mixture with a smaller amount of water. In principle, however, the production of the wet mixture from the dry mixture is effected by methods known to those skilled in the art and typically used to produce concrete, mortar, plaster, etc. For instance, those skilled in the art in particular know the amount of water which is to be mixed with the dry mixture to produce the wet mixture.

Typically, the wet mixture is produced by mixing the dry mixture with water in an amount of at least 20% by weight based on the mineral binder present in the dry mixture; by way of example 20-150% by weight of water may be used, based on the mineral binder present in the dry mixture. In further embodiments, the mixing with water can be effected in an amount of for example 20-100% by weight, preferably 20-60% by weight, more preferably 25-55% by weight, more preferably still 30-50% by weight, in particular 35-45% by weight, based in each case on the mineral binder present in the dry mixture.

The present invention in particular also comprises the embodiments specified below.
(1) A wetting agent composition comprising (i) a wetting agent selected from the group consisting of anionic, cationic, nonionic wetting agents and a combination of these wetting agents, and (ii) a pulverulent carrier.
(2) The wetting agent composition according to (1), wherein the wetting agent is nonionic.
(3) The wetting agent composition according to (1) or (2), wherein the wetting agent comprises structural units which are represented by the following formula

—(CH₂CH₂O)ₓ—H,
where x can take a value of 1 to 210.
(4) The wetting agent composition according to any of (1)-(3), wherein the wetting agent is a block copolymer formed from ethylene oxide and propylene oxide.
(5) The wetting agent composition according to any of (1)-(3), wherein the wetting agent is a fatty alcohol alkoxylate.
(6) The wetting agent composition according to any of (1)-(3), wherein the wetting agent is a polyethylene glycol.
(7) The wetting agent composition according to (6), wherein the wetting agent is a polyethylene glycol of the formula

HO(CH₂CH₂O)ₓ—H
where 3≤x≤210.
(8) The wetting agent composition according to (6) or (7), wherein the wetting agent is a polyethylene glycol of the formula

HO(CH₂CH₂O)ₓ—H
where 5≤x≤150.
(9) The wetting agent composition according to (6) or (7), wherein the wetting agent is a polyethylene glycol of the formula

HO(CH₂CH₂O)ₓ—H
where 10≤x≤100.
(10) The wetting agent composition according to (6) or (7), wherein the wetting agent is a polyethylene glycol of the formula

HO(CH₂CH₂O)ₓ—H
where 10≤x≤60.
(11) The wetting agent composition according to (6) or (7), wherein the wetting agent is a polyethylene glycol of the formula

HO(CH₂CH₂O)ₓ—H
where 10≤x≤40.
(12) The wetting agent composition according to (4), wherein the wetting agent is a block copolymer formed from ethylene oxide and propylene oxide of the formula

HO(CH₂CH₂O)ₓ—(CH₂CH(CH₃)O)_{y}—(CH₂CH₂O)_{z}H
where 1≤x≤100,
   1≤y≤100,
   1≤z≤100.
(13) The wetting agent composition according to (4) or (12), wherein the wetting agent is a block copolymer formed from ethylene oxide and propylene oxide of the formula

HO(CH₂CH₂O)ₓ—(CH₂CH(CH₃)O)_{y}—(CH₂CH₂O)_{z}H
where 1≤x≤100,
   1≤y≤100,
   1≤z≤100,
   5%≤(44x+44z)/(44x+58y+44z)≤90%.
(14) The wetting agent composition according to (4) or (12), wherein the wetting agent is a block copolymer formed from ethylene oxide and propylene oxide of the formula

HO(CH₂CH₂O)ₓ—(CH₂CH(CH₃)O)_{y}—(CH₂CH₂O)_{z}H
where 1≤x≤100,
   1≤y≤100,
   1≤z≤100,
   10%≤(44x+44z)/(44x+58y+44z)≤80%.
(15) The wetting agent composition according to (4) or (12), wherein the wetting agent is a block copolymer formed from ethylene oxide and propylene oxide of the formula

HO(CH₂CH₂O)ₓ—(CH₂CH(CH₃)O)_{y}—(CH₂CH₂O)_{z}H
where 1≤x≤90,
   13≤y≤70,
   1≤z≤90,
   10%≤(44x+44z)/(44x+58y+44z)≤80%.
(16) The wetting agent composition according to (4) or (12), wherein the wetting agent is a block copolymer formed from ethylene oxide and propylene oxide of the formula

HO(CH₂CH₂O)ₓ—(CH₂CH(CH₃)O)_{y}—(CH₂CH₂O)_{z}H
where 10≤x≤90,
   25≤y≤60,
   10≤z≤90,
   10%≤(44x+44z)/(44x+58y+44z)≤80%.
(17) The wetting agent composition according to (4) or (12), wherein the wetting agent is a block copolymer formed from ethylene oxide and propylene oxide of the formula

HO(CH₂CH₂O)ₓ—(CH₂CH(CH₃)O)_{y}—(CH₂CH₂O)_{z}H
where 10≤x≤90,
   35≤y≤50,
   10≤z≤90,
   10%≤(44x+44z)/(44x+58y+44z)≤80%.
(18) The wetting agent composition according to (5), wherein the wetting agent is a fatty alcohol alkoxylate of the formula

RO(CH₂CH₂O)ₓ—(CH₂CH(CH₃)O)_{y}—H
where 2≤x≤80,
   0≤y≤80,
   R=C₈₋₁₈-alkyl or C₈₋₁₈-alkenyl with 1, 2 or 3 double bonds.
(19) The wetting agent composition according to (5) or (18), wherein the wetting agent is a fatty alcohol alkoxylate of the formula

RO(CH₂CH₂O)ₓ—(CH₂CH(CH₃)O)_{y}—H
where 2≤x≤80,
   2≤y≤80,
   R=C₈₋₁₈-alkyl or C₈₋₁₃-alkenyl with 1, 2 or 3 double bonds.
(20) The wetting agent composition according to (5) or (18), wherein the wetting agent is a fatty alcohol alkoxylate of the formula

RO(CH₂CH₂O)ₓ—(CH₂CH(CH₃)O)_{y}—H
where 2≤x≤80,
   2≤y≤80,
   R=C₁₂₋₁₈-alkyl or C₁₂₋₁₈-alkenyl with 1, 2 or 3 double bonds.
(21) The wetting agent composition according to (5) or (18), wherein the wetting agent is a fatty alcohol alkoxylate of the formula

RO(CH₂CH₂O)ₓ—(CH₂CH(CH₃)O)_{y}—H
where 2≤x≤80,
   2≤y≤80,
   R=C₁₆₋₁₈-alkyl or C₁₆₋₁₈-alkenyl with 1, 2 or 3 double bonds.
(22) The wetting agent composition according to (5) or (18), wherein the wetting agent is a fatty alcohol alkoxylate of the formula

RO(CH₂CH₂O)ₓ—(CH₂CH(CH₃)O)_{y}—H
where 2≤x≤10,
   2≤y≤10,
   R=C₈₋₁₈-alkyl or C₈₋₁₈-alkenyl with 1, 2 or 3 double bonds.
(23) The wetting agent composition according to (5) or (18), wherein the wetting agent is a fatty alcohol alkoxylate of the formula

RO(CH₂CH₂O)ₓ—(CH₂CH(CH₃)O)_{y}—H
where 2≤x≤10,
   2≤y≤10,
   R=C₁₂₋₁₄-alkyl.
(24) The wetting agent composition according to (5) or (18), wherein the wetting agent is a fatty alcohol alkoxylate of the formula

RO(CH₂CH₂O)ₓ—(CH₂CH(CH₃)O)_{y}—H
where 2≤x≤80,
   y=0,
   R=C₈₋₁₈-alkyl or C₈₋₁₈-alkenyl with 1, 2 or 3 double bonds.
(25) The wetting agent composition according to (5) or (18), wherein the wetting agent is a fatty alcohol alkoxylate of the formula

RO(CH₂CH₂O)ₓ—(CH₂CH(CH₃)O)_{y}—H
where 2≤x≤80,
   y=0,
   R=C₁₂₋₁₈-alkyl or C₁₂₋₁₈-alkenyl with 1, 2 or 3 double bonds.
(26) The wetting agent composition according to (5) or (18), wherein the wetting agent is a fatty alcohol alkoxylate of the formula

RO(CH₂CH₂O)ₓ—(CH₂CH(CH₃)O)_{y}—H
where 2≤x≤80,
   y=0,
   R=C₁₆₋₁₈-alkyl or C₁₆₋₁₈-alkenyl with 1, 2 or 3 double bonds.
(27) The wetting agent composition according to (5) or (18), wherein the wetting agent is a fatty alcohol alkoxylate of the formula

RO(CH₂CH₂O)ₓ—(CH₂CH(CH₃)O)_{y}—H
where 30≤x≤80,
   y=0,
   R=C₁₂₋₁₈-alkyl or C₁₂₋₁₈-alkenyl with 1, 2 or 3 double bonds.
(28) The wetting agent composition according to (5) or (18), wherein the wetting agent is a fatty alcohol alkoxylate of the formula

RO(CH₂CH₂O)ₓ—(CH₂CH(CH₃)O)_{y}—H
where 30≤x≤80,
   y=0,
   R=C₁₂₋₁₈-alkyl or C₁₂₋₁₈-alkenyl with 1, 2 or 3 double bonds.
(29) The wetting agent composition according to (5) or (18), wherein the wetting agent is a fatty alcohol alkoxylate of the formula

RO(CH₂CH₂O)ₓ—(CH₂CH(CH₃)O)_{y}—H
where 30≤x≤80,
   y=0,
   R=C₁₆₋₁₈-alkyl or C₁₆₋₁₈-alkenyl with 1, 2 or 3 double bonds.
(30) The wetting agent composition according to any of (1)-(29), wherein the carrier is an inorganic material.
(31) The wetting agent composition according to any of (1)-(29), wherein the carrier is selected from the group consisting of silicon dioxide, silicates and aluminosilicates, alkaline earth metal carbonates, alkaline earth metal phosphates, pulverulent amorphous rock melts and mixtures of these.
(32) The wetting agent composition according to any of (1)-(29), wherein the carrier is selected from alkaline earth metal carbonates, alkaline earth metal phosphates, alkaline earth metal silicates, alkaline earth metal silicate hydrates and mixtures of these.
(33) The wetting agent composition according to any of (1)-(29), wherein the carrier is selected from magnesium carbonate, calcium carbonate, magnesium phosphate, calcium phosphate, magnesium silicate, calcium silicate, magnesium silicate hydrate, calcium silicate hydrate and mixtures of these.
(34) The wetting agent composition according to any of (1)-(29), wherein the carrier is selected from magnesium silicate hydrate, calcium silicate hydrate and mixtures of these.
(35) The wetting agent composition according to any of (1)-(29), wherein the carrier is selected from sheet silicates and sheet aluminosilicates and mixtures of these.
(36) The wetting agent composition according to any of (1)-(29), wherein the carrier is selected from bentonite, kaolin, montmorillonite and mixtures of these.
(37) The wetting agent composition according to any of (1)-(29), wherein the carrier is selected from natural silicon dioxide, such as kieselguhr, amorphous silicon dioxide, pyrolytic silicon dioxide, precipitated silicon dioxide and mixtures of these.
(37) The wetting agent composition according to any of (1)-(29), wherein the carrier is calcium silicate hydrate.
(38) The wetting agent composition according to any of (1)-(37), wherein the carrier has a specific surface area of more than 10 m²/g, determined by the BET method by means of nitrogen sorption.
(39) The wetting agent composition according to any of (1)-(37), wherein the carrier has a specific surface area of more than 20 m²/g, determined by the BET method by means of nitrogen sorption.
(40) The wetting agent composition according to any of (1)-(37), wherein the carrier has a specific surface area of more than 30 m²/g, determined by the BET method by means of nitrogen sorption.
(41) The wetting agent composition according to any of (1)-(37), wherein the carrier has a specific surface area of more than 40 m²/g, determined by the BET method by means of nitrogen sorption.
(42) The wetting agent composition according to any of (1)-(37), wherein the carrier has a specific surface area of 1 to 200 m²/g, determined by the BET method by means of nitrogen sorption.
(43) The wetting agent composition according to any of (1)-(37), wherein the carrier has a specific surface area of 30 to 150 m²/g, determined by the BET method by means of nitrogen sorption.
(44) The wetting agent composition according to any of (1)-(29), wherein the carrier is selected from magnesium silicate hydrate, calcium silicate hydrate and mixtures of these and has a specific surface area of more than 10 m²/g, determined by the BET method by means of nitrogen sorption.
(45) The wetting agent composition according to any of (1)-(29), wherein the carrier is selected from magnesium silicate hydrate, calcium silicate hydrate and mixtures of these and has a specific surface area of more than 20 m²/g, determined by the BET method by means of nitrogen sorption.
(46) The wetting agent composition according to any of (1)-(29), wherein the carrier is selected from magnesium silicate hydrate, calcium silicate hydrate and mixtures of these and has a specific surface area of more than 30 m²/g, determined by the BET method by means of nitrogen sorption.
(47) The wetting agent composition according to any of (1)-(29), wherein the carrier is selected from magnesium silicate hydrate, calcium silicate hydrate and mixtures of these and has a specific surface area of more than 40 m²/g, determined by the BET method by means of nitrogen sorption.
(48) The wetting agent composition according to any of (1)-(29), wherein the carrier is selected from magnesium silicate hydrate, calcium silicate hydrate and mixtures of these and has a specific surface area of 1 to 200 m²/g, determined by the BET method by means of nitrogen sorption.
(49) The wetting agent composition according to any of (1)-(29), wherein the carrier is selected from magnesium silicate hydrate, calcium silicate hydrate and mixtures of these and has a specific surface area of 30 to 150 m²/g, determined by the BET method by means of nitrogen sorption.
(50) The wetting agent composition according to any of (1)-(3), wherein the carrier is selected from magnesium silicate hydrate, calcium silicate hydrate and mixtures of these and has a specific surface area of 30 to 150 m²/g, determined by the BET method by means of nitrogen sorption, and the wetting agent is a polyethylene glycol of the formula

HO(CH₂CH₂O)ₓ—H
where 3≤x≤210.
(51) The wetting agent composition according to any of (1)-(3), wherein the carrier is selected from magnesium silicate hydrate, calcium silicate hydrate and mixtures of these and has a specific surface area of 30 to 150 m²/g, determined by the BET method by means of nitrogen sorption, and the wetting agent is a polyethylene glycol of the formula

HO(CH₂CH₂O)ₓ—H
where 5≤x≤150.
(52) The wetting agent composition according to any of (1)-(3), wherein the carrier is selected from magnesium silicate hydrate, calcium silicate hydrate and mixtures of these and has a specific surface area of 30 to 150 m²/g, determined by the BET method by means of nitrogen sorption, and the wetting agent is a polyethylene glycol of the formula

HO(CH₂CH₂O)ₓ—H
where 10≤x≤100.
(53) The wetting agent composition according to any of (1)-(3), wherein the carrier is selected from magnesium silicate hydrate, calcium silicate hydrate and mixtures of these and has a specific surface area of 30 to 150 m²/g, determined by the BET method by means of nitrogen sorption, and the wetting agent is a polyethylene glycol of the formula

HO(CH₂CH₂O)ₓ—H
where 10≤x≤60.
(54) The wetting agent composition according to any of (1)-(3), wherein the carrier is selected from magnesium silicate hydrate, calcium silicate hydrate and mixtures of these and has a specific surface area of 30 to 150 m²/g, determined by the BET method by means of nitrogen sorption, and the wetting agent is a polyethylene glycol of the formula

HO(CH₂CH₂O)ₓ—H
where 10≤x≤40.
(55) The wetting agent composition according to any of (1)-(3), wherein the carrier is selected from magnesium silicate hydrate, calcium silicate hydrate and mixtures of these and has a specific surface area of 30 to 150 m²/g, determined by the BET method by means of nitrogen sorption, and the wetting agent is a block copolymer formed from ethylene oxide and propylene oxide of the formula

HO(CH₂CH₂O)ₓ—(CH₂CH(CH₃)O)_{y}—(CH₂CH₂O)_{z}H
where 1≤x≤100,
   1≤y≤100,
   1≤z≤100.
(56) The wetting agent composition according to any of (1)-(3), wherein the carrier is selected from magnesium silicate hydrate, calcium silicate hydrate and mixtures of these and has a specific surface area of 30 to 150 m²/g, determined by the BET method by means of nitrogen sorption, and the wetting agent is a block copolymer formed from ethylene oxide and propylene oxide of the formula

HO(CH₂CH₂O)ₓ—(CH₂CH(CH₃)O)_{y}—(CH₂CH₂O)_{z}H
where 1≤x≤100,
   1≤y≤100,
   1≤z≤100,
   5%≤(44x+44z)/(44x+58y+44z)≤90%.
(57) The wetting agent composition according to any of (1)-(3), wherein the carrier is selected from magnesium silicate hydrate, calcium silicate hydrate and mixtures of these and has a specific surface area of 30 to 150 m²/g, determined by the BET method by means of nitrogen sorption, and the wetting agent is a block copolymer formed from ethylene oxide and propylene oxide of the formula

HO(CH₂CH₂O)ₓ—(CH₂CH(CH₃)O)_{y}—(CH₂CH₂O)_{z}H
where 1≤x≤100,
   1≤y≤100,
   1≤z≤100,
   10%≤(44x+44z)/(44x+58y+44z)≤80%.
(58) The wetting agent composition according to any of (1)-(3), wherein the carrier is selected from magnesium silicate hydrate, calcium silicate hydrate and mixtures of these and has a specific surface area of 30 to 150 m²/g, determined by the BET method by means of nitrogen sorption, and the wetting agent is a block copolymer formed from ethylene oxide and propylene oxide of the formula

HO(CH₂CH₂O)ₓ—(CH₂CH(CH₃)O)_{y}—(CH₂CH₂O)_{z}H
where 1≤x≤90,
   13≤y≤70,
   1≤z≤90,
   10%≤(44x+44z)/(44x+58y+44z)≤80%.
(59) The wetting agent composition according to any of (1)-(3), wherein the carrier is selected from magnesium silicate hydrate, calcium silicate hydrate and mixtures of these and has a specific surface area of 30 to 150 m²/g, determined by the BET method by means of nitrogen sorption, and the wetting agent is a block copolymer formed from ethylene oxide and propylene oxide of the formula

HO(CH₂CH₂O)ₓ—(CH₂CH(CH₃)O)_{y}—(CH₂CH₂O)_{z}H
where 10≤x≤90,
   25≤y≤60,
   10≤z≤90,
   10%≤(44x+44z)/(44x+58y+44z)≤80%.
(60) The wetting agent composition according to any of (1)-(3), wherein the carrier is selected from magnesium silicate hydrate, calcium silicate hydrate and mixtures of these and has a specific surface area of 30 to 150 m²/g, determined by the BET method by means of nitrogen sorption, and the wetting agent is a block copolymer formed from ethylene oxide and propylene oxide of the formula

HO(CH₂CH₂O)ₓ—(CH₂CH(CH₃)O)_{y}—(CH₂CH₂O)_{z}H
where 10≤x≤90,
   35≤y≤50,
   10≤z≤90,
   10%≤(44x+44z)/(44x+58y+44z)≤80%.
(61) The wetting agent composition according to any of (1)-(3), wherein the carrier is selected from magnesium silicate hydrate, calcium silicate hydrate and mixtures of these and has a specific surface area of 30 to 150 m²/g, determined by the BET method by means of nitrogen sorption, and the wetting agent is a fatty alcohol alkoxylate of the formula

RO(CH₂CH₂O)ₓ—(CH₂CH(CH₃)O)_{y}—H
where 2≤x≤80,
   0≤y≤80,
   R=C₈₋₁₈-alkyl or C₈₋₁₈-alkenyl with 1, 2 or 3 double bonds.
(62) The wetting agent composition according to any of (1)-(3), wherein the carrier is selected from magnesium silicate hydrate, calcium silicate hydrate and mixtures of these and has a specific surface area of 30 to 150 m²/g, determined by the BET method by means of nitrogen sorption, and the wetting agent is a fatty alcohol alkoxylate of the formula

RO(CH₂CH₂O)ₓ—(CH₂CH(CH₃)O)_{y}—H
where 2≤x≤80,
   2≤y≤80,
   R=C₈₋₁₈-alkyl or C₈₋₁₈-alkenyl with 1, 2 or 3 double bonds.
(63) The wetting agent composition according to any of (1)-(3), wherein the carrier is selected from magnesium silicate hydrate, calcium silicate hydrate and mixtures of these and has a specific surface area of 30 to 150 m²/g, determined by the BET method by means of nitrogen sorption, and the wetting agent is a fatty alcohol alkoxylate of the formula

RO(CH₂CH₂O)ₓ—(CH₂CH(CH₃)O)_{y}—H
where 2≤x≤80,
   2≤y≤80,
   R=C₁₂₋₁₈-alkyl or C₁₂₋₁₈-alkenyl with 1, 2 or 3 double bonds.
(64) The wetting agent composition according to any of (1)-(3), wherein the carrier is selected from magnesium silicate hydrate, calcium silicate hydrate and mixtures of these and has a specific surface area of 30 to 150 m²/g, determined by the BET method by means of nitrogen sorption, and the wetting agent is a fatty alcohol alkoxylate of the formula

RO(CH₂CH₂O)ₓ—(CH₂CH(CH₃)O)_{y}—H
where 2≤x≤80,
   2≤y≤80,
   R=C₁₆₋₁₈-alkyl or C₁₆₋₁₈-alkenyl with 1, 2 or 3 double bonds.
(65) The wetting agent composition according to any of (1)-(3), wherein the carrier is selected from magnesium silicate hydrate, calcium silicate hydrate and mixtures of these and has a specific surface area of 30 to 150 m²/g, determined by the BET method by means of nitrogen sorption, and the wetting agent is a fatty alcohol alkoxylate of the formula

RO(CH₂CH₂O)ₓ—(CH₂CH(CH₃)O)_{y}—H
where 2≤x≤10,
   2≤y≤10,
   R=C₈₋₁₈-alkyl or C₈₋₁₈-alkenyl with 1, 2 or 3 double bonds.
(66) The wetting agent composition according to any of (1)-(3), wherein the carrier is selected from magnesium silicate hydrate, calcium silicate hydrate and mixtures of these and has a specific surface area of 30 to 150 m²/g, determined by the BET method by means of nitrogen sorption, and the wetting agent is a fatty alcohol alkoxylate of the formula

RO(CH₂CH₂O)ₓ—(CH₂CH(CH₃)O)_{y}—H
where 2≤x≤10,
   2≤y≤10,
   R=C₁₂₋₁₄-alkyl.
(67) The wetting agent composition according to any of (1)-(3), wherein the carrier is selected from magnesium silicate hydrate, calcium silicate hydrate and mixtures of these and has a specific surface area of 30 to 150 m²/g, determined by the BET method by means of nitrogen sorption, and the wetting agent is a fatty alcohol alkoxylate of the formula

RO(CH₂CH₂O)ₓ—(CH₂CH(CH₃)O)_{y}—H
where 2≤x≤80,
   y=0,
   R=C₈₋₁₈-alkyl or C₈₋₁₈-alkenyl with 1, 2 or 3 double bonds.
(68) The wetting agent composition according to any of (1)-(3), wherein the carrier is selected from magnesium silicate hydrate, calcium silicate hydrate and mixtures of these and has a specific surface area of 30 to 150 m²/g, determined by the BET method by means of nitrogen sorption, and the wetting agent is a fatty alcohol alkoxylate of the formula

RO(CH₂CH₂O)ₓ—(CH₂CH(CH₃)O)_{y}—H
where 2≤x≤80,
   y=0,
   R=C₁₂₋₁₈-alkyl or C₁₂₋₁₈-alkenyl with 1, 2 or 3 double bonds.
(69) The wetting agent composition according to any of (1)-(3), wherein the carrier is selected from magnesium silicate hydrate, calcium silicate hydrate and mixtures of these and has a specific surface area of 30 to 150 m²/g, determined by the BET method by means of nitrogen sorption, and the wetting agent is a fatty alcohol alkoxylate of the formula

RO(CH₂CH₂O)ₓ—(CH₂CH(CH₃)O)_{y}—H
where 2≤x≤80,
   y=0,
   R=C₁₆₋₁₈-alkyl or C₁₆₋₁₈-alkenyl with 1, 2 or 3 double bonds.
(70) The wetting agent composition according to any of (1)-(3), wherein the carrier is selected from magnesium silicate hydrate, calcium silicate hydrate and mixtures of these and has a specific surface area of 30 to 150 m²/g, determined by the BET method by means of nitrogen sorption, and the wetting agent is a fatty alcohol alkoxylate of the formula

RO(CH₂CH₂O)ₓ—(CH₂CH(CH₃)O)_{y}—H
where 30≤x≤80,
   y=0,
   R=C₈₋₁₈-alkyl or C₈₋₁₈-alkenyl with 1, 2 or 3 double bonds.
(71) The wetting agent composition according to any of (1)-(3), wherein the carrier is selected from magnesium silicate hydrate, calcium silicate hydrate and mixtures of these and has a specific surface area of 30 to 150 m²/g, determined by the BET method by means of nitrogen sorption, and the wetting agent is a fatty alcohol alkoxylate of the formula

RO(CH₂CH₂O)ₓ—(CH₂CH(CH₃)O)_{y}—H
where 30≤x≤80,
   y=0,
   R=C₁₂₋₁₈-alkyl or C₁₂₋₁₈-alkenyl with 1, 2 or 3 double bonds.
(72) The wetting agent composition according to any of (1)-(3), wherein the carrier is selected from magnesium silicate hydrate, calcium silicate hydrate and mixtures of these and has a specific surface area of 30 to 150 m²/g, determined by the BET method by means of nitrogen sorption, and the wetting agent is a fatty alcohol alkoxylate of the formula

RO(CH₂CH₂O)ₓ—(CH₂CH(CH₃)O)_{y}—H
where 30≤x≤80,
   y=0,
   R=C₁₆₋₁₈-alkyl or C₁₆₋₁₈-alkenyl with 1, 2 or 3 double bonds.
(73) The wetting agent composition according to any of (1)-(72), wherein the wetting agent is present in an amount of 1-50% by weight, based on the weight of the carrier.
(74) The wetting agent composition according to any of (1)-(72), wherein the wetting agent is present in an amount of 10-40% by weight, based on the weight of the carrier.
(75) The wetting agent composition according to any of (1)-(72), wherein the wetting agent is present in an amount of 20-35% by weight, based on the weight of the carrier.
(76) The wetting agent composition according to any of (1)-(72), wherein the wetting agent is at least one nonionic wetting agent and the wetting agent composition does not comprise any anionic wetting agent.
(77) The wetting agent composition according to (76), wherein the at least one nonionic wetting agent is selected from block copolymers formed from ethylene oxide oligomers and propylene oxide oligomers according to any of (4) and (12)-(17), fatty alcohol alkoxylates according to any of (5) and (18)-(29), polyethylene glycols according to any of (6)-(11) and combinations of these nonionic wetting agents.
(78) The wetting agent composition according to (76) or (77), wherein the wetting agent is present in an amount of 1-50% by weight, based on the weight of the carrier.
(79) The wetting agent composition according to (76) or (77), wherein the wetting agent is present in an amount of 10-40% by weight, based on the weight of the carrier.
(80) The wetting agent composition according to (76) or (77), wherein the wetting agent is present in an amount of 20-35% by weight, based on the weight of the carrier.
(81) A dry mixture comprising the wetting agent composition according to any of (1)-(80) and at least one mineral binder.
(82) The dry mixture according to (81), wherein the mineral binder is selected from hydraulic binders, non-hydraulic binders and combinations of these.
(83) The dry mixture according to (81) or (82), wherein the mineral binder is a hydraulic binder selected from gypsum, geopolymers, cement, Portland cement, high-alumina cement, mixtures of cement with fly ash, silica fume, slag, slag sand and ground limestone or burnt lime, mixtures of Portland cement with fly ash, silica fume, slag, slag sand and ground limestone or burnt lime, mixtures of high-alumina cement with fly ash, silica fume, slag, slag sand and ground limestone or burnt lime, calcium sulfoaluminate and latent hydraulic binders such as pozzolans in combination with slaked lime, quicklime or cement.
(84) The dry mixture according to (81) or (82), wherein the mineral binder is a non-hydraulic binder selected from slaked lime, quicklime, calcined magnesium carbonate, loam and mixtures of these.
(85) The dry mixture according to any of (81)-(84), wherein the wetting agent composition is present in an amount of 0.01-1% by weight, based on the weight of the at least one hydraulic binder.
(86) The dry mixture according to any of (81)-(84), wherein the wetting agent composition is present in an amount of 0.03-0.5% by weight, based on the weight of the at least one hydraulic binder.
(87) The dry mixture according to any of (81)-(84), wherein the wetting agent composition is as defined in any of (4)-(80).
(88) A wet mixture obtainable by mixing the dry mixture according to any of (81)-(87) with water.
(89) The wet mixture according to (88), wherein water is used in an amount of at least 20% by weight, based on the mineral binder present in the dry mixture.
(90) The wet mixture according to any of (88), wherein water is used in an amount of at least 20-150% by weight, based on the mineral binder present in the dry mixture.
(91) The wet mixture according to (88), wherein water is used in an amount of at least 20-100% by weight, based on the mineral binder present in the dry mixture.
(92) The wet mixture according to (88), wherein water is used in an amount of at least 20-60% by weight, based on the mineral binder present in the dry mixture.
(93) The wet mixture according to (88), wherein water is used in an amount of at least 25-55% by weight, based on the mineral binder present in the dry mixture.
(94) The wet mixture according to (88), wherein water is used in an amount of at least 30-50% by weight, based on the mineral binder present in the dry mixture.
(95) The wet mixture according to (88), wherein water is used in an amount of at least 35-45% by weight, based on the mineral binder present in the dry mixture.

### EXAMPLES

### Example 1: Preparation of a Wetting Agent Composition

The wetting agent used is a block copolymer with the name “Pluronic® PE 9400” (BASF SE, Ludwigshafen, Germany).

This block copolymer has the general formula

HO(CH₂CH₂O)ₓ—(CH₂CH(CH₃)O)_{y}—(CH₂CH₂O)_{z}H

and consists of a central block of repeating units derived from propylene oxide (PO) and terminal blocks of repeating units derived from ethylene oxide (EO). The central block of repeating PO units has a molar mass of approx. 2750 g/mol, corresponding to approx. 47 PO units (y≈47). The central block of repeating PO units corresponds to about 60% of the total molecular weight, that is to say that the terminal blocks of repeating EO units correspond to about 40% of the total molecular weight. Each of the two terminal blocks therefore has a molar mass of approx. 925 g/mol, corresponding to approx. 21 EO units (x+z≈42).

The carrier used is Circosil® 0.1 (Cirkel GmbH & Co.KG, Haltern am See, Germany). Circosil® 0.1 is a calcium silicate hydrate powder with a specific surface area of 40.39 m²/g (determined by a BET method using nitrogen with a Nova Station C type instrument (Quantachrome Instruments, Boynton Beach, Fla. 33426, USA) and the Quantachrome NovaWin software; degassing temperature 60.0° C., degassing time 5 hours, adsorption temperature 77.3 K, equilibration time 120 seconds each time, measurement at 5 relative pressures). The d50 particle size is 100 μm (determined by dispersing the sieve fractions in water and measuring the particle size using a CILAS 1064 type instrument (CILAS, Orleans, France) by means of a laser diffraction method).

30 parts by weight of the wetting agent are heated to 45° C. and jetted onto 70 parts by weight of the carrier. The carrier material is stirred in the process in order to achieve intensive mixing. After all of the wetting agent has been added to the carrier, the mixing is continued for 15 minutes.

### Example 2: Preparation of a Wetting Agent Composition

30 parts by weight of the wetting agent used in example 1 were applied by the same method as in example 1 to 70 parts by weight of kieselguhr (“Celite 400 LC”, Lehmann&Voss&Co. KG, Hamburg, Germany).

### Comparative Example 1: Producing a Dry Mixture

The dry mixture produced is a gypsum-based spackling compound with the following composition.

| | | |
|---|---|---|
| Calcium sulfate β-hemihydrate | 250.00 | g |
| Calcium sulfate α-hemihydrate | 100.00 | g |
| Ground limestone (“Omyacarb 15 AL”) | 150.00 | g |
| Cellulose ether (“Tylose MH 60000 P6”) | 3.50 | g |
| Acrylamide-based rheology modifier (“Starvis ® T 50 F”) | 0.20 | g |
| Starch ether-based rheology modifier (“Starvis ® SE 35”) | 0.25 | g |
| Polymer-based retarder (“HyCon ® R 7200”) | 0.04 | g |
| Total mass of the dry mixture: | 503.99 | g |

### Example 3: Producing a Dry Mixture

As dry mixture, the gypsum-based spackling compound according to comparative example 1 is produced with addition of 2.53 g of the wetting agent composition from example 1. The overall mixture (506.52 g) thus comprises 0.5% by weight of the wetting agent compositions and 0.15% by weight of the wetting agent.

### Example 4: Producing a Dry Mixture

As dry mixture, a gypsum-based spackling compound is produced with a composition as in example 3. However, the wetting agent composition prepared in example 2 is used instead of the wetting agent composition prepared in example 1.

### Comparative Example 2: Producing a Dry Mixture

As dry mixture, the gypsum-based spackling compound according to comparative example 1 is produced with addition of 0.76 g of Pluronic® PE 9400 (without carrier material). The overall mixture (504.75 g) thus comprises 0.15% by weight of the wetting agent.

### Comparative Example 3: Producing a Dry Mixture

As dry mixture, the gypsum-based spackling compound according to comparative example 1 is produced with addition of 2.53 g of Pluronic® PE 9400 (without carrier material). The overall mixture (506.52 g) thus comprises 0.5% by weight of the wetting agent.

Wetting Time Test Method

10 g of the dry mixture are placed in a powder funnel, from which the dry mixture is allowed to fall into a beaker with an internal diameter of approx. 70 mm and in which there is situated sufficient tap water (water hardness approx. 11° dH) with a temperature of 23° C. to set a filling level of 26 mm (approx. 100 ml). The powder funnel is attached in such a way that the height of the fall for the dry mixture between the powder funnel and the surface of the water is 50 mm. The time needed for the dry mixture to sink completely beneath the surface of the water is measured. This time is denoted the wetting time.

The following wetting times were determined for the dry mixtures according to examples 3 and 4 and comparative examples 1 to 3.

| | Content (based on the overall mixture) | | Wetting |
|---|---|---|---|
| | Wetting agent | Wetting agent | time |
| | composition [wt. %] | [wt. %] | [s] |
| Comparative | 0.0 | 0.0 | 24 (100%) |
| example 1 | | | |
| V147 | | | |
| Comparative | — | 0.15 | 18 (75%) |
| example 2 | | | |
| V163 | | | |
| Comparative | — | 0.5 | 20 (83%) |
| example 3 | | | |
| V164 | | | |
| Example 3 | 0.5 | 0.15 | 13 (54%) |
| V160 | | | |
| Example 4 | 0.5 | 0.15 | 15 (63%) |
| V162 | | | |

The wetting time for a dry mixture without wetting agent is defined as 100% as a reference point. These data show that the wetting time can be reduced to 75% by addition of an unsupported wetting agent, that is to say a wetting agent which is not situated on a carrier (comparative example 2). This wetting time cannot be reduced further by increased addition of the unsupported wetting agent (comparative example 3), either. Addition of a supported wetting agent (examples 3 and 4) makes it possible to reduce the wetting time to 54% and 63%, respectively, even though the content of the wetting agent in the mixture is not higher than in comparative example 2.

The wetting agent composition according to the present invention thus makes it possible to achieve a reduced wetting time of the dry mixture without increased use of wetting agent.

1. A wetting agent composition, comprising
(I) an anionic wetting agent, cationic wetting agent, and/or a nonionic wetting agent; and
(ii) a pulverulent carrier.

2. The composition of claim 1, wherein the nonionic wetting agent is present and optionally comprises:
(i) a polyethylene glycol of a formula
HO(CH₂CH₂O)ₓ—H,
wherein 3≤x≤210;
(ii) a block copolymer comprising, in polymerized form, ethylene oxide and propylene oxide, of a formula
HO(CH₂CH₂O)ₓ—(CH₂CH(CH₃)O)_{y}—(CH₂CH₂O)_{z}H,
wherein 1≤x≤100,
1≤y≤100,
1≤z≤100; and/or
(iii) a fatty alcohol alkoxylate of a formula
RO(CH₂CH₂O)ₓ—(CH₂CH(CH₃)O)_{y}—H,
wherein 2≤x≤80,
0≤y≤80, and
R is C₈₋₁₈-alkyl or C₈₋₁₈-alkenyl with 1, 2, or 3 double bonds.

3. The composition of claim 1, wherein the wetting agent comprises:
(i) a polyethylene glycol of a formula
HO(CH₂CH₂O)ₓ—H,
wherein 5≤x≤150;
(ii) a block copolymer comprising, in polymerized form, ethylene oxide and propylene oxide, of a formula
HO(CH₂CH₂O)ₓ—(CH₂CH(CH₃)O)_{y}—(CH₂CH₂O)H,
wherein
1≤x≤100,
1≤y≤100,
1≤z≤100,
5%≤(44x+44z)/(44x+58y+44z)≤90%;
and/or
(iii) a fatty alcohol alkoxylate of a formula
RO(CH₂CH₂O)ₓ—(CH₂CH(CH₃)O)_{y}—H
wherein 2≤x≤80,
2≤y≤80,
R is C₈₋₁₈-alkyl or C₈₋₁₈-alkenyl with 1, 2, or 3 double bonds.

4. The composition of claim 1, wherein the wetting agent is a fatty alcohol alkoxylate of a formula
RO(CH₂CH₂O)ₓ—(CH₂CH(CH₃)O)_{y}—H,
wherein
2≤x≤80,
y is 0,
R is C₈₋₁₈-alkyl or C₈₋₁₈-alkenyl with 1, 2, or 3 double bonds.

5. The composition of claim 1, wherein the carrier is an inorganic material.

6. The composition of claim 1, wherein the carrier comprises a silicon dioxide, silicate, aluminosilicate, alkaline earth metal carbonate, alkaline earth metal phosphate, and/or pulverulent amorphous rock melt.

7. The composition of claim 1, wherein the carrier comprises an alkaline earth metal carbonate, alkaline earth metal phosphate, alkaline earth metal silicate, and/or alkaline earth metal silicate hydrate.

8. The composition of claim 1, wherein the carrier comprises a sheet silicate, sheet aluminosilicate, natural silicon dioxide, amorphous silicon dioxide, pyrolytic silicon dioxide, and/or precipitated silicon dioxide.

9. The composition of claim 1, wherein the carrier is calcium silicate hydrate.

10. The composition of claim 1, wherein the carrier has a specific surface area of more than 10 m²/g, determined by the BET method by means of nitrogen sorption.

11. The composition of claim 1, wherein the carrier has a specific surface area of 1 to 200 m²/g, determined by the BET method by means of nitrogen sorption.

12. The wetting agent composition of claim 1, comprising no anionic wetting agent.

13. The wetting agent composition of claim 12, comprising a block copolymer comprising, in polymerized form, an ethylene oxide oligomer and a propylene oxide oligomer, fatty alcohol alkoxylate, a polyethylene glycol of formula (I)
HO(CH₂CH₂O)ₓ—H (I),
wherein 3≤x≤210;
a block copolymer comprising, in polymerized form, ethylene oxide and propylene oxide, of formula (II)
HO(CH₂CH₂O)ₓ—(CH₂CH(CH₃)O)_{y}—(CH₂CH₂O)_{z}H (I),
wherein 1≤x≤100,
1≤y≤100,
1≤z≤100; and/or
(iii) a fatty alcohol alkoxylate of formula (III)
RO(CH₂CH₂O)ₓ—(CH₂CH(CH₃)O)_{y}—H (III),
wherein
2≤x≤80,
0≤y≤80, and
R is C₈₋₁₈-alkyl or C₈₋₁₈-alkenyl with 1, 2, or 3 double bonds.

14. The composition of claim 12, wherein the wetting agent is present in an amount of from 1 to 50 wt. %, based on carrier weight.

15. The composition of claim 12, wherein the wetting agent is present in an amount of from 10 to 40 wt. %, based on carrier weight.

16. A dry mixture, comprising:
the wetting agent composition of claim 1; and
a mineral binder.

17. The dry mixture of claim 16, wherein the wetting agent composition is present in an amount of from 0.01 to 1 wt. %.

18. A wet mixture, obtained by mixing the dry mixture of claim 16 with water.

19. The wet mixture of claim 18, wherein water is used in an amount of at least 20 wt. %, based on the mineral binder present in the dry mixture.
